(19) United States
(12) Patent Application Publication
(10) Pub. No.: US 2024/0363096 A1
(43) Pub. Date: Oct. 31, 2024

(54) SOUND GENERATOR, COMPUTER-IMPLEMENTED METHOD FOR PRODUCING SOUND INFORMATION, COMPUTER PROGRAM AND NON-VOLATILE DATA CARRIER

(71) Applicant: MYVOX AB, Stockholm (SE)

(72) Inventor: Josef HANSSON, Sundbyberg (SE)

(73) Assignee: MYVOX AB, Stockholm (SE)

(21) Appl. No.: 18/682,619

(22) PCT Filed: Jun. 17, 2022
(86) PCT No.: PCT/SE2022/050599

§ 371 Date: Feb. 9, 2024

(30) Foreign Application Priority Data
Aug. 13, 2021 (SE) 2151000-3

(51) Int. Cl. G10K 11/34; G10K 11/36; G10K 15/02

(52) U.S. Cl. CPC G10K 11/348; G10K 11/36; G10K 15/02

(57) ABSTRACT

A sound generator comprising: a digital processing unit, an amplifying circuit and an array of ultrasonic transducers. The digital processing unit mixes a data signal with a digital carrier signal to produce a modulated digital signal. The data signal represents sound information on a digital format and the digital carrier signal has a constant frequency. The amplifying circuit receives the modulated digital signal, and based thereon produces an amplified analog ultrasonic-frequency signal. The array of ultrasonic transducers emits at least one ultrasonic signal beam having an envelope representing the sound information. Thus, for example, audible sound may be produced.

### TECHNICAL FIELD

The present invention relates generally to the production of audio waves. Especially, the invention relates to a sound generator, for example to produce sounds in the audible frequency range, and a corresponding computer-implemented method. The invention also relates to a computer program and a non-volatile data carrier storing such a computer program.

### BACKGROUND

It is known to modulate an audio signal onto an ultrasound sinusoidal signal from a signal generator using an analog mixing circuit. The resulting amplitude modulated ultrasonic signal here has an envelope reflecting the variations, i.e. audio information, in the audio signal. Thus, inter alia, as described in the article Gan, W S., Yang, J., Kamakura, T., “A review of parametric acoustic array in air”, Applied Acoustics, 73 (2012), a parametric acoustic array may be used to create a narrow directional beam of audible sound.

By modulating audio onto an ultrasonic carrier wave, an end-fire virtual array of audible sources is created due to demodulation of the combined signal in the air, which, in turn, is the result of nonlinear effects.

As an alternative to the analog mixing circuit, at least one dedicated digital signal processor (DSP) may be used to perform the audio preprocessing and the modulation. In other words, the mixing as such is performed in the digital domain.

Examples of such solutions are presented in the article Ahn, H. et al., “A Critical Step to Using a Parametric Array Loudspeaker in Mobile Devices”, Sensors 2019, 19, 4449; 14 Oct. 2019 doi: 10.3390/s19204449 and in the patent documents WO 03/019125, US 2007/0121968 and U.S. Pat. No. 6,445,804 respectively.

Due to nonlinearities in the demodulation of the combined wave of the ultrasonic signal and the audio signal in the air, the thus generated audio signal becomes distorted. The sound experienced by a human listener may therefore be perceived to have poor quality. Theoretically, the generated audio pressure is proportional to the square of the amplitude of the ultrasonic carrier. Consequently, the distortion could be compensated for by taking the square root of the audio signal before modulation.

In practice, however, because of various shortcomings of the components involved, this is seldom sufficient to fully cancel out the distortion and recreate the original audio signal after demodulation. For example, due to a limited bandwidth of the transducers, more complex preprocessing of the audio signal and modulation is typically needed to mitigate the distortion in the in-air demodulation.

Irrespective of whether the mixing is performed in the analog or the digital domain, the above-mentioned analog handling of the analog audio signal requires a comparatively large number of bulky components. This, in turn, results in a large-sized and expensive design. Moreover, the design becomes inflexible and difficult to improve iteratively because any developments also requires updating of the hardware.

### SUMMARY

The object of the present invention is therefore to offer a solution that mitigates the above problems and renders it possible to reduce the hardware requirements on an acoustic sound generator.

According to one aspect of the invention, the object is achieved by a sound generator containing digital processing unit, an amplifying circuit and an array of ultrasonic transducers. The digital processing unit is configured to mix a data signal with a digital carrier signal to produce a modulated digital signal. Preferably, both signals are produced internally in the digital processing unit, however, the data signal may be received from a unit external to the digital processing unit. The data signal represents sound information, e.g. voice and/or music, on a digital format and the digital carrier signal has a constant frequency, for example in the range 30 kHz to 480 kHz. Preferably the digital carrier signal has a frequency being at least two times as high as a frequency of a highest frequency component of the data signal. The amplifying circuit is configured to receive the modulated digital signal, and based thereon produce an amplified analog ultrasonic-frequency signal. Based on the amplified analog ultrasonic-frequency signal, the array of ultrasonic transducers is configured to emit at least one ultrasonic signal beam having an envelope representing the sound information.

The above sound generator is advantageous because it enables the modulated digital signal to be produced directly in the digital domain, i.e. without requiring any input from an analog signal source. Consequently, modifications and/or tweaking of the modulation scheme can be made exclusively in programming code. In other words, the system design may be improved and updated while maintaining the hardware unaltered.

According to one embodiment of this aspect of the invention, the digital processing unit is configured to mix the data signal with the digital carrier signal by performing at least one modulation operation in which the digital carrier signal is caused to vary in response to the data signal. Such digital modulation is desirable because it transfers the information in the data signal to the resulting ultrasonic signal in an efficient manner.

Preferably, the digital processing unit is further configured to perform at least one preprocessing operation to reduce an amount of distortion in the modulated digital signal. Namely, such operations the digital processing unit may easily be coordinated with the modulation operations. For example, the at least one preprocessing operation may involve performing a square root operation on the data signal aiming at compensating for the fact that the generated audio pressure is proportional to the square of the amplitude of the ultrasonic carrier.

According to other embodiments of this aspect of the invention, the at least one modulation operation involves applying a modulation scheme based on an amplitude function, a single sideband modulation function and/or an orthogonal correction modified amplitude function. Thus, a high flexibility is attained in terms of modulation schemes.

According to another embodiment of this aspect of the invention, the amplifying circuit contains a digital-to-analog converter and a first power amplifier. The digital-to-analog converter is configured to receive the modulated digital signal and based thereon produce an analog signal in the form of an ultrasonic-frequency signal being amplitude modulated with respect to the sound information. The first power amplifier is of class A, B, AB or C type and is configured to receive the analog signal and based thereon produce the amplified analog ultrasonic-frequency signal. Thereby, the design becomes very flexible with respect to the amplification technology applied.

According to yet another embodiment of this aspect of the invention, the digital processing unit is configured to mix the data signal with the digital carrier signal to produce the modulated digital signal by applying a pulse width modulation scheme. This is desirable because it enables direct amplification of the output signal, i.e. without any intermediate digital-to-analog conversion.

Preferably, therefore in this embodiment, the amplifying circuit contains a second power amplifier configured to receive the modulated digital signal and based thereon produce the amplified analog ultrasonic-frequency signal. The second power amplifier, in turn, may include a switching controller configured to receive the modulated digital signal, and a lowpass filter communicatively connected to the switching controller and configured to output the amplified analog ultrasonic-frequency signal. This accomplishes a compact and efficient circuitry implementation of the second power amplifier.

According to still another embodiment of this aspect of the invention the digital processing unit is configured to generate the data signal. In other words, no input is needed to the digital processing unit. Naturally, this vouches for a highly uncomplicated and compact implementation of the design.

According to yet another embodiment of this aspect of the invention, the digital processing unit is configured to receive the data signal from a signal source external to the digital processing unit. Thereby, the data signal may originate essentially from any entity capable of producing acoustic information. Of course, this does not preclude that the digital processing unit is also configured to generate the data signal internally, which renders the design very flexible indeed.

According to another aspect of the invention, the object is achieved by a computer-implemented method for producing sound information. The method involves mixing a data signal with a digital carrier signal using a digital processing unit to produce a modulated digital signal. The data signal represents the sound information on a digital format and the digital carrier signal has a constant frequency. The method further involves amplifying the modulated digital signal using an amplifying circuit to produce an amplified analog ultrasonic-frequency signal, and receiving the amplified analog ultrasonic-frequency signal in an array of ultrasonic transducers. Additionally, at least one ultrasonic signal beam is emitted from the array of ultrasonic transducers. The at least one ultrasonic signal beam has an envelope representing the sound information, and the at least one ultrasonic signal beam is based on the amplified analog ultrasonic-frequency signal. The advantages of this method, as well as the preferred embodiments thereof, are apparent from the discussion above with reference to the system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows a sound generator according to a first embodiment of the invention;

FIGS. 2a-c illustrate an analog audio signal, an analog ultrasonic signal and an analog ultrasonic-frequency signal modulated with the analog audio signal respectively;

FIG. 3 shows a sound generator according to a second embodiment of the invention;

FIG. 4 shows a power amplifier configured to receive a modulated digital signal and based thereon produce an amplified analog ultrasonic-frequency signal; and

FIG. 5 illustrates, by means of a flow diagram, the general method according to the invention.

### DETAILED DESCRIPTION

In FIG. 1, we see a sound generator 100 according to a first embodiment of the invention. The sound generator 100 includes a digital processing unit 110, e.g. represented by a DSP or a general purpose processor, an amplifying circuit 120 and an array of ultrasonic transducers 130.

The digital processing unit 110 is configured to mix a data signal D_{audio} with a digital carrier signal D_{US} to produce a modulated digital signal D_{M}. The digital carrier signal D_{US} preferably has a frequency in the ultrasonic range, i.e. from 30 kHz to 480 kHz. According to one embodiment of the invention, the digital carrier signal D_{US} has a frequency being at least two times as high as a frequency of a highest frequency component of the data signal D_{audio}. The data signal D_{audio} represents sound information A_{audio}, for example in the form of a recorded voice and/or music on a digital format, and the digital carrier signal D_{US} has a constant frequency.

According to one embodiment of the invention, a signal source 111 included in the digital processing unit 110 is configured to produce the data signal D_{audio}. According to another embodiment of the invention, the data signal D_{audio} instead originates from a signal source 105 external to the digital processing unit 110. Naturally, the two signal source options may also be combined in one implementation, such that the digital processing unit 110 either receives data signal D_{audio} from the external signal source 105, or produces the data signal D_{audio} internally via the signal source 111.

The amplifying circuit 120 is configured to receive the modulated digital signal D_{M}, and based thereon produce an amplified analog ultrasonic-frequency signal AM_{US}. According to a first embodiment of the invention, the amplifying circuit 120 contains a digital-to-analog converter 122 and a first power amplifier 126. The digital-to-analog converter 122 is configured to receive the modulated digital signal D_{M} and based thereon produce an analog signal M_{US} in the form of an ultrasonic-frequency signal being amplitude modulated with respect to the sound information A_{audio}. The first power amplifier 126 may contain amplification circuitry, which is configured to conduct current through the full period of the signal, i.e. class A type; conduct current through half the period of the signal, i.e. class B type; conduct current through an angle intermediate to class A and B; or conduct current through less than half the period of the signal, i.e. class C type.

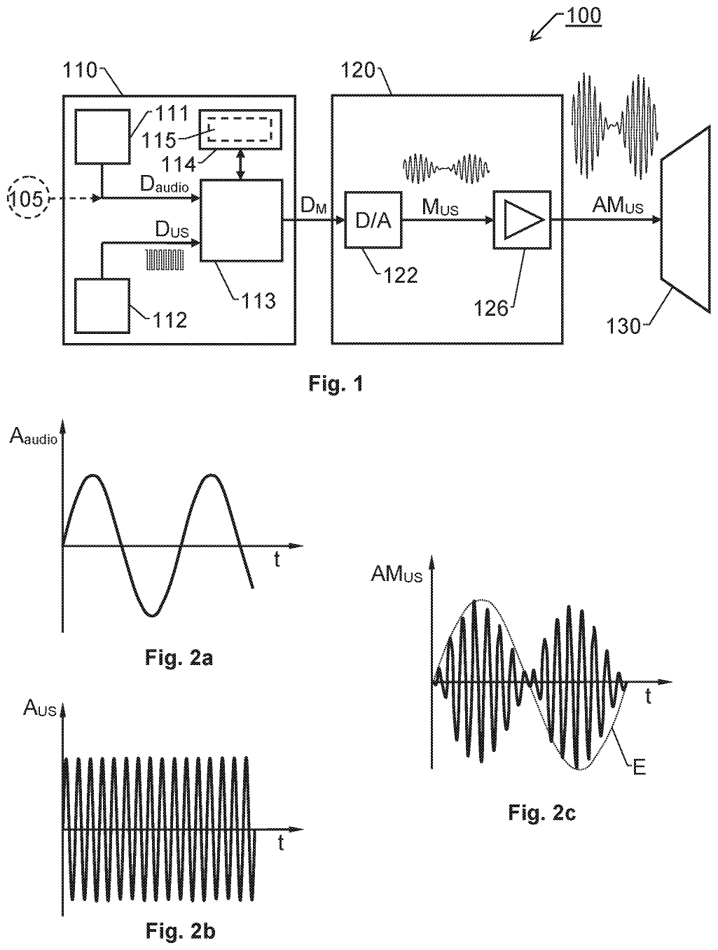

Now, for illustrating purposes, we refer to the graphs in FIGS. 2a, 2b and 2c. FIG. 2a illustrates sound information in the form of an analog audio signal A_{audio} as a function of time t, and FIG. 2b illustrates an analog ultrasonic signal A_{US} having a constant amplitude as a function of time t.

FIG. 2c illustrates an amplified analog ultrasonic-frequency signal AM_{US} as a function of time t, which amplified analog ultrasonic-frequency signal AM_{US} has been produced by analog mixing of the analog audio signal A_{audio} with the analog ultrasonic signal A_{US} and amplifying the signal resulting from said mixing. The amplified analog ultrasonic-frequency signal AM_{US} has an envelope E embodying an acoustic signal that will be demodulated in a volume of air, or other fluid transmission medium, through which the amplified analog ultrasonic-frequency signal AM_{US} is propagated as an acoustic wave.

According to the invention, the array of ultrasonic transducers 130 is configured to receive the amplified analog ultrasonic-frequency signal AM_{Us} and based thereon emit at least one ultrasonic signal beam having an envelope E representing the sound information A_{audio}. In other words, when the amplified analog ultrasonic-frequency signal AM_{US} propagates through the air, the audio information represented by the data signal D_{audio} will be demodulated.

As described initially, a parametric acoustic array is capable of creating a narrow directional beam of audible sound. By modulating audio onto an ultrasonic carrier wave, an end-fire virtual array of audible sources is created due to demodulation of the combined signal in the air, which, in turn, is the result of nonlinear effects.

Using a primary signal source containing an array of ultrasonic transducers enables steering the beam of audible sound by adjusting a respective phase delay of individual transducers in the array of ultrasonic transducers.

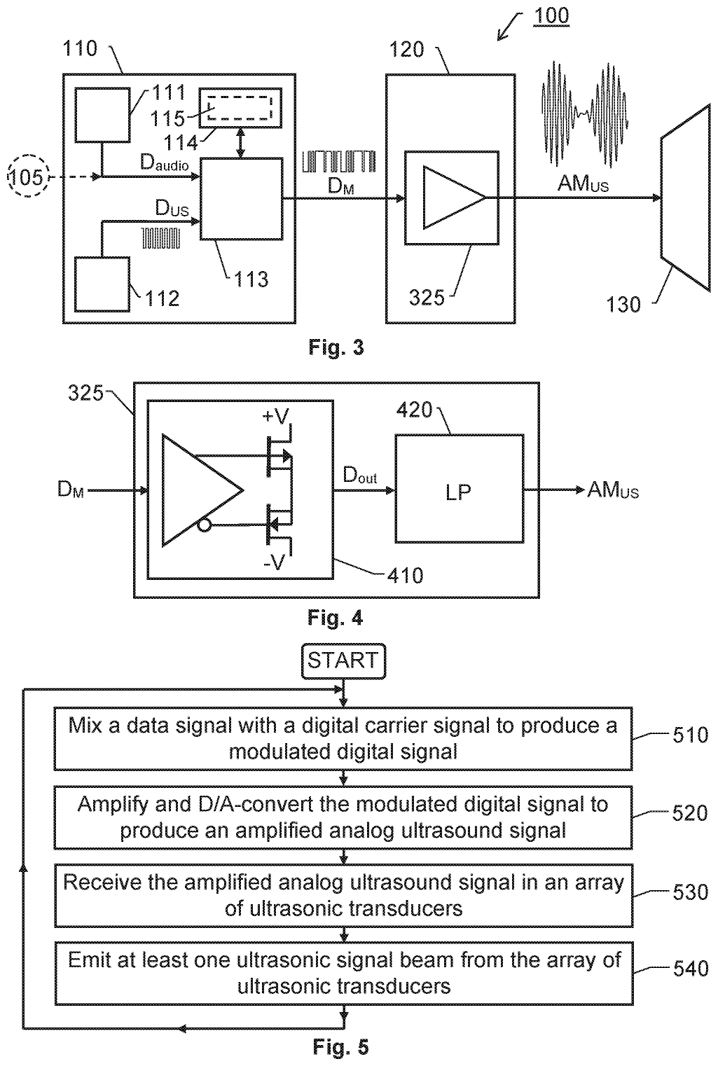

According to one embodiment of the invention, the digital processing unit 110 is configured to mix the data signal D_{audio} with the digital carrier signal D_{US} by performing at least one modulation operation causing the digital carrier signal D_{US} to vary in response to the data signal D_{audio}. For example, as will be described below referring to FIG. 3, this variation may occur in the form of pulse width variations in the modulated digital signal D_{M}.

According to alternative embodiments of the invention, the at least one modulation operation involves applying a modulation scheme based on an amplitude function, a single sideband modulation function or an orthogonal correction modified amplitude function.

Here, the square root amplitude modulation may be expressed as:

$$g ( t ) = \sqrt{1 + f ( t )} sin {ω}_{c} t ,$$

where f(t) represents the data signal and sinω_{c}t represents the carrier signal.

The single sideband modulation may be expressed as:

$$g ( t ) = Real ( ( 1 + H ( f ) ( t ) ) {e}^{j {ω}_{c} t} ) ,$$

where H is the Hilbert transform.

The Orthogonal correction modified amplitude modulation may be expressed as:

$$g ( t ) = \sqrt{( 1 + f ( t ) )} sin {ω}_{c} t + \sqrt{1 - {f}^{2} ( t )} cos {ω}_{c} t .$$

It is further preferable if the digital processing unit 110 is configured to perform at least one preprocessing operation to reduce an amount of distortion in the modulated digital signal D_{M}. Namely, due to various shortcomings of the components involved, e.g. bandwidth limitations of the transducers in the array of ultrasonic transducers 130, preprocessing operations may be needed to compensate for such shortcomings. Especially, in comparison to making corresponding adjustments in the hardware, it is highly efficient to employ such preprocessing operations in the digital processing unit 110.

For instance, the at least one preprocessing operation may involve performing a square root operation on the data signal D_{audio}. Namely, the audio pressure that the array of ultrasonic transducers 130 generates in the air is proportional to the square of the amplitude of the amplified analog ultrasonic-frequency signal AM_{US}. Therefore, said square root operation provides a compensation for this physical phenomenon, at least in theory.

FIG. 3 shows a sound generator 100 according to a second embodiment of the invention. Here, the digital processing unit 110 is configured to mix the data signal D_{audio} with the digital carrier signal D_{US} to produce the modulated digital signal D_{M} by applying a pulse width modulation scheme. The modulated digital signal D_{M} is schematically illustrated in FIG. 3 above the signal connection between the digital processing unit 110 and the amplifying circuit 120.

Preferably, in the second embodiment, the amplifying circuit 120 contains a second power amplifier 325, which is configured to receive the modulated digital signal D_{M} and based thereon produce the amplified analog ultrasonic-frequency signal AM_{US}, without any intermediate, specific, digital-to-analog conversion. Instead, such conversion and amplification is effected jointly in the second power amplifier 325.

FIG. 4 shows the power amplifier 325 according to one embodiment of the invention, which contains a switching controller 410 and a lowpass filter 420.

The switching controller 410 is configured to receive the modulated digital signal D_{M}. The lowpass filter 420 is communicatively connected to the switching controller 410 to receive an output signal Dₒᵤₜ there from. The lowpass filter 420 is further configured to produce the amplified analog ultrasonic-frequency signal AM_{US} based on the output signal Dₒᵤₜ.

As described above, the digital processing unit 110 is configured to effect mixing of the data signal D_{audio} with a digital carrier signal D_{US}, and thus produce the modulated digital signal D_{M}. According to the invention, this is accomplished by executing a computer program 115. The digital processing unit 110 may therefore include a memory unit 114, i.e. a non-volatile data carrier, storing the computer program 115, which memory unit 114, in turn, contains software for making a processing circuitry in the form of at least one processor 113 in the digital processing unit 110 execute said mixing when the computer program 115 is run on the at least one processor 113.

Below, and with reference to the flow diagram in FIG. 5, the computer-implemented method according to the invention for producing sound information A_{audio} is described. Here, only a first step 510 is actually executed by the computer program 115 in the digital processing unit 110. However, since the subsequent steps 520 to 540 in the proposed procedure, which are effected in hardware, follow automatically in direct and inevitable response to the result of step 510, the entire method is deemed to be computer-implemented.

In first step 510, a data signal D_{audio} is mixed with a digital carrier signal D_{US} to produce a modulated digital signal D_{M}. The data signal D_{audio} contains digitized sound information, preferably representing tones in the audible spectrum, such as a voice and/or music, the digital carrier signal D_{US} has a constant frequency and the mixing is performed using a digital processing unit.

A subsequent step 520 amplifies the modulated digital signal D_{M} using an amplifying circuit. As a result, an amplified analog ultrasonic-frequency signal AM_{US} is produced.

In a step 530 thereafter, an array of ultrasonic transducers receives the amplified analog ultrasonic-frequency signal AM_{US}, and as a result, least one ultrasonic signal beam is emitted from the array of ultrasonic transducers in a step 540. The at least one ultrasonic signal beam has an envelope representing the sound information A_{audio}. Consequently, the at least one ultrasonic signal beam will be demodulated into sound waves in the air surrounding the array of ultrasonic transducers.

After step 540, the procedure loops back to step 510 for continued mixing of the data signal D_{audio} with the digital carrier signal D_{US}. It is worth noticing that, in practice, the steps 510 to 540 are performed contemporaneously, however based on different pieces of data and signal segments respectively. Namely, while for example the amplified analog ultrasound signal is received in step 530, which amplified analog ultrasound signal is based on a first set of pieces of data; step 510 mixes the data signal D_{audio} with the digital carrier signal D_{US}, which data signal D_{audio} contains a second set pieces of data having been received after the first set of pieces of data, and so on.

All of the process steps, as well as any sub-sequence of steps, described with reference to FIG. 5 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A sound generator comprising:
a digital processing unit configured to mix a data signal with a digital carrier signal to produce a modulated digital signal, the data signal representing sound information on a digital format and the digital carrier signal having a constant frequency;
an amplifying circuit configured to receive the modulated digital signal, and based thereon produce an amplified analog ultrasonic-frequency signal; and
an array of ultrasonic transducers configured to emit at least one ultrasonic signal beam having an envelope representing the sound information, which at least one ultrasonic signal beam is based on the amplified analog ultrasonic-frequency signal.

2. The sound generator according to claim 1, wherein the digital processing unit is configured to mix the data signal with the digital carrier signal by performing at least one modulation operation causing the digital carrier signal to vary in response to the data signal.

3. The sound generator according to claim 2, wherein the digital processing unit is further configured to perform at least one preprocessing operation to reduce an amount of distortion in the modulated digital signal.

4. The sound generator according to claim 2, wherein the at least one preprocessing operation comprises performing a square root operation on the data signal.

5. The sound generator according to claim 2, wherein the at least one modulation operation comprises applying a modulation scheme based on one of:
an amplitude function;
a single sideband modulation function; and
an orthogonal correction modified amplitude function.

6. The sound generator according to claim 1, wherein the amplifying circuit comprises:
a digital-to-analog converter configured to receive the modulated digital signal and based thereon produce an analog signal in the form of an ultrasonic-frequency signal being amplitude modulated with respect to the sound information; and
a first power amplifier of class A, B, AB or C type configured to receive the analog signal and based thereon produce the amplified analog ultrasonic-frequency signal.

7. The sound generator according to claim 1, wherein the digital processing unit is configured to mix the data signal with the digital carrier signal to produce the modulated digital signal by applying a pulse width modulation scheme.

8. The sound generator according to claim 7, wherein the amplifying circuit comprises a second power amplifier configured to receive the modulated digital signal and based thereon produce the amplified analog ultrasonic-frequency signal.

9. The sound generator according to claim 8, wherein the second power amplifier comprises:
a switching controller configured to receive the modulated digital signal; and
a lowpass filter communicatively connected to the switching controller and configured to output the amplified analog ultrasonic-frequency signal.

10. The sound generator according to claim 1, wherein the digital processing unit is configured to generate the data signal.

11. The sound generator according to claim 1, wherein the digital processing unit is configured to receive the data signal from a signal source external to the digital processing unit.

12. The sound generator according to claim 1, wherein the digital carrier signal has a constant frequency being at least two times as high as a frequency of a highest frequency component of the data signal.

13. A computer-implemented method for producing sound information, the method comprising:
mixing a data signal with a digital carrier signal using a digital processing unit to produce a modulated digital signal, the data signal representing the sound information on a digital format and the digital carrier signal having a constant frequency;
amplifying the modulated digital signal using an amplifying circuit to produce an amplified analog ultrasonic-frequency signal;
receiving the amplified analog ultrasonic-frequency signal in an array of ultrasonic transducers; and
emitting from the array of ultrasonic transducers at least one ultrasonic signal beam having an envelope representing the sound information, which at least one ultrasonic signal beam is based on the amplified analog ultrasonic-frequency signal.

14. The method according to claim 13, wherein the mixing of the data signal with the digital carrier signal comprises performing at least one modulation operation to cause the digital carrier signal to vary in response to the data signal.

15. The method according to claim 14, wherein the mixing of the data signal with the digital carrier signal further comprises performing at least one preprocessing operation to reduce an amount of distortion in the modulated digital signal.

16. The method according to claim 15, wherein the at least one preprocessing operation comprises performing a square root operation on the data signal.

17. The method according to claim 14, wherein the at least one modulation operation comprises applying a modulation scheme based on one of:
an amplitude function;
a single sideband modulation function; and
an orthogonal correction modified amplitude function.

18. The method according to claim 13, wherein the mixing of the data signal with the digital carrier signal to produce the modulated digital signal comprises applying a pulse width modulation scheme.

19. The method according to claim 13, comprising generating the data signal using the digital processing unit

20. The method according to claim 13, comprising receiving the data signal from a signal source external to the digital processing unit .

21. The method according to claim 13, wherein the digital carrier signal has a constant frequency being at least two times as high as a frequency of a highest frequency component of the data signal.

22. A computer program product comprising a computer program code stored on a non-transitory computer-readable medium, said computer program product used for producing sound information, said computer program code comprising computer instructions to cause one or more processing units to perform the following operations:
mixing a data signal with a digital carrier signal using a digital processing unit to produce a modulated digital signal, the data signal representing the sound information on a digital format and the digital carrier signal having a constant frequency;
amplifying the modulated digital signal using an amplifying circuit to produce an amplified analog ultrasonic-frequency signal;
receiving the amplified analog ultrasonic-frequency signal in an array of ultrasonic transducers; and
emitting from the array of ultrasonic transducers at least one ultrasonic signal beam having an envelope representing the sound information, which at least one ultrasonic signal beam is based on the amplified analog ultrasonic-frequency signal.

23. A non-transitory computer-readable medium comprising a computer program code, said computer program product used for producing sound information, said computer program code comprising computer instructions to cause one or more processing units to perform the following operations:
mixing a data signal with a digital carrier signal using a digital processing unit to produce a modulated digital signal, the data signal representing the sound information on a digital format and the digital carrier signal having a constant frequency;
amplifying the modulated digital signal using an amplifying circuit to produce an amplified analog ultrasonic-frequency signal;
receiving the amplified analog ultrasonic-frequency signal in an array of ultrasonic transducers; and
emitting from the array of ultrasonic transducers at least one ultrasonic signal beam having an envelope representing the sound information, which at least one ultrasonic signal beam is based on the amplified analog ultrasonic-frequency signal.
